(19) United States
(12) Patent Application Publication
(10) Pub. No.: US 2024/0096130 A1
(43) Pub. Date: Mar. 21, 2024

(54) AUTHENTICATION SYSTEM, PROCESSING METHOD, AND NON-TRANSITORY STORAGE MEDIUM

(71) Applicant: NEC Corporation, Minato-ku, Tokyo (JP)

(72) Inventor: Mariko Hagiwara, Tokyo (JP)

(73) Assignee: NEC Corporation, Minato-ku, Tokyo (JP)

(21) Appl. No.: 18/272,749

(22) PCT Filed: Jan. 28, 2022
(86) PCT No.: PCT/JP2022/003351

§ 371 Date: Jul. 17, 2023

(30) Foreign Application Priority Data
Apr. 9, 2021 (JP) 2021-066319

(51) Int. Cl. G06V 40/16; G06V 10/75; G06V 20/64; G06V 40/50

(52) U.S. Cl. CPC G06V 40/171; G06V 10/751; G06V 20/64; G06V 40/50

(57) ABSTRACT

The disclosure provides an authentication system (10) including: an acquisition unit (11) that acquires a processing target image including a face of a user; a per-part evaluation unit (13) that evaluates a change for each part of a face, based on a registration image being preregistered and the processing target image; a verification unit (12) that performs face verification processing, based on the registration image and the processing target image; and a notification unit (14) that notifies a notification target person of an evaluation result of a change for each part of a face when a verification score of the face verification processing satisfies a predetermined condition.

### TECHNICAL FIELD

The disclosure relates to an authentication system, a processing method, and a program.

### BACKGROUND ART

A technique related to the disclosure is disclosed in Patent Documents 1 to 3.

Patent Document 1 discloses a technique for accumulating and verifying a feature of face information by a part of a face, attribute information, and related information without accumulating face information itself about a person detected from an image.

Patent Document 2 discloses that first feature information and second feature information being acquired by extracting a plurality of parts needed for biometric authentication from an image of a face, and performing arithmetic processing on a position and a feature are verified, and thereby face authentication is performed, and discloses that, when an aging change is detected based on the first feature information and the second feature information, notification that prompts an update of the first feature information is made to a user. The first feature information is registration data, and the second feature information is data acquired for authentication.

Patent Document 3 discloses a technique for verifying a face image being cut from a wide angle image and a face image being preregistered, and a technique for correcting the face image described above, based on a position and an orientation of a subject in the image, and performing verification, based on the face image after the correction.

### RELATED DOCUMENT

### Patent Document

Patent Document 1: Japanese Patent Application Publication No. 2012-203592
Patent Document 2: Japanese Patent Application Publication No. 2013-206232
Patent Document 3: Japanese Patent Application Publication No. 2020-154408

### DISCLOSURE OF THE INVENTION

### Technical Problem

In recent years, a face authentication technique is widely used. The face authentication technique has the following problem.

Patent Document 2 discloses that, when an aging change is detected based on first feature information being registration data, and second feature information being data acquired for face authentication, notification that prompts an update of registered image data is made to a user. However, when an update is simply prompted, such as “please update registered image data”, a user cannot understand why the update of the registered image data is needed. In other words, the user cannot appropriately decide whether the update of the registered image data is necessary.

The disclosure has a challenge to be able to appropriately decide whether an update of image data registered for face authentication is necessary.

### Solution to Problem

The disclosure provides an authentication system including:
an acquisition unit that acquires a processing target image including a face of a user;
a per-part evaluation unit that evaluates a change for each part of a face, based on a registration image being preregistered and the processing target image;
a verification unit that performs face verification processing, based on the registration image and the processing target image; and
a notification unit that notifies a notification target person of an evaluation result of a change for each part of a face when a verification score of the face verification processing satisfies a predetermined condition.

Further, the disclosure provides a processing method including,
by a computer:
acquiring a processing target image including a face of a user;
evaluating a change for each part of a face, based on a registration image being preregistered and the processing target image;
performing face verification processing, based on the registration image and the processing target image; and
notifying a notification target person of an evaluation result of a change for each part of a face when a verification score of the face verification processing satisfies a predetermined condition.

Further, the disclosure provides a program causing a computer to function as:
an acquisition unit that acquires a processing target image including a face of a user;
a per-part evaluation unit that evaluates a change for each part of a face, based on a registration image being preregistered and the processing target image;
a verification unit that performs face verification processing, based on the registration image and the processing target image; and
a notification unit that notifies a notification target person of an evaluation result of a change for each part of a face when a verification score of the face verification processing satisfies a predetermined condition.

### BRIEF DESCRIPTION OF THE DRAWINGS

FIG. 1 is a diagram illustrating one example of a hardware configuration of an authentication system according to the present example embodiment.

FIG. 2 is a diagram illustrating one example of a functional block diagram of the authentication system according to the present example embodiment.

FIG. 3 is a diagram illustrating one example of a flow of processing of the authentication system according to the present example embodiment.

FIG. 4 is a diagram illustrating one example of a flow of processing of the authentication system according to the present example embodiment.

FIG. 5 is a diagram schematically illustrating one example of information processed by the authentication system according to the present example embodiment.

FIG. 6 is a diagram illustrating one example of a functional block diagram of the authentication system according to the present example embodiment.

FIG. 7 is a diagram illustrating one example of a flow of processing of the authentication system according to the present example embodiment.

### DESCRIPTION OF EMBODIMENTS

Hereinafter, example embodiments of this disclosure will be described with reference to the drawings. Note that, in all of the drawings, a similar component has a similar reference sign, and description thereof will be appropriately omitted.

First, a background of this disclosure will be described in order to facilitate understanding of the example embodiments of this disclosure.

In image data registered for face authentication, a face of a person changes due to various factors such as aging, a lifestyle, and a surgical operation, and thus it may be appropriate to update the image data to latest image data even when an update timing is not reached. That is a case where, for example, a change seen with eyes of a person is great, and the image data are not appropriate as image data to be registered for authentication even when personal authentication is performed by a face authentication technique at a high level. Thus, the image data registered for face authentication need to be updated to latest image data at an appropriate timing of an individual in response to a change in a face. Further, a related technique does not include a means for appropriately deciding whether an update of registered image data is necessary.

According to the example embodiments of this disclosure described below, whether an update of image data registered for face authentication is necessary can be decided at an appropriate timing of an individual in response to a change in a face.

### First Example Embodiment

### Overview

An authentication system according to the present example embodiment has a function of performing personal identification of a user by using face authentication. When the authentication system acquires a processing target image, the authentication system performs face verification processing, based on the processing target image and a registration image being preregistered for face authentication. Then, the authentication system notifies a user of a result of the face verification processing. The “processing target image” is an image including a face of a user. In the present example embodiment, an image including a face of a user and being input to the authentication system for face authentication is the processing target image. The “user” is a user of a service that can be received by a person who succeeds in face authentication performed by the authentication system.

Further, when the authentication system acquires a processing target image, the authentication system evaluates a change for each part of a face, based on the processing target image and a registration image being preregistered for face authentication. Then, when a verification score of the face verification processing described above based on the registration image and the processing target image is equal to or less than a reference value, the authentication system notifies a notification target person of an evaluation result of the change for each part of the face. The “notification target person” is a person who needs to be notified or who is preferably notified of information about an update of the registration image, and, for example, a user himself/herself, an operator of the authentication system, a person in charge of a facility that uses the authentication system, and the like are exemplified.

In this way, the authentication system extracts, based on a verification score of the face verification processing based on a registration image and a processing target image, a user who needs to consider whether an update of the registration image is necessary. Then, the authentication system notifies a notification target person of an evaluation result of material information for deciding whether the update is necessary for the extracted user, specifically, a change for each part of a face. The notification target person can appropriately decide whether the update of the registration image being registered for face authentication is necessary, based on the evaluation result of the change for each part of the face.

### “Hardware Configuration”

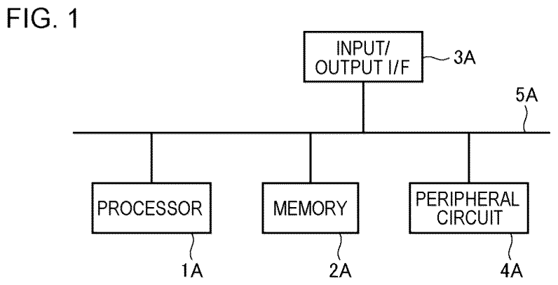

Next, one example of a hardware configuration of an authentication system 10 will be described. FIG. 1 is a diagram illustrating the hardware configuration example of the authentication system 10. Each functional unit included in the authentication system 10 is achieved by any combination of hardware and software concentrating on a central processing unit (CPU) of any computer, a memory, a program loaded into the memory, a storage unit such as a hard disc that stores the program, and a network connection interface. The storage unit can also store a program downloaded from a storage medium such as a compact disc (CD), a server on the Internet, and the like in addition to a program previously stored at a stage of shipping of an apparatus. Then, various modification examples of an achievement method and an apparatus thereof are then understood by a person skilled in the art.

As illustrated in FIG. 1, the authentication system 10 includes a processor 1A, a memory 2A, an input/output interface 3A, a peripheral circuit 4A, and a bus 5A. Various modules are included in the peripheral circuit 4A. The authentication system 10 may not include the peripheral circuit 4A. Note that, the authentication system 10 may be formed of a plurality of apparatuses separated physically and/or logically, or may be formed of one apparatus integrated physically and logically. When the authentication system 10 is formed of a plurality of apparatuses separated physically and/or logically, each of the plurality of apparatuses can include the hardware configuration described above.

The bus 5A is a data transmission path for the processor 1A, the memory 2A, the peripheral circuit 4A, and the input/output interface 3A to transmit and receive data to and from one another. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can output an instruction to each of modules, and perform an arithmetic operation, based on an arithmetic result of the modules.

### “Functional Configuration”

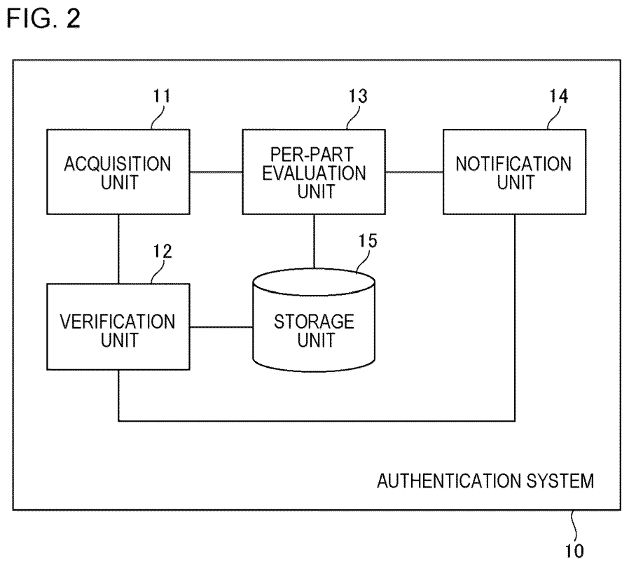

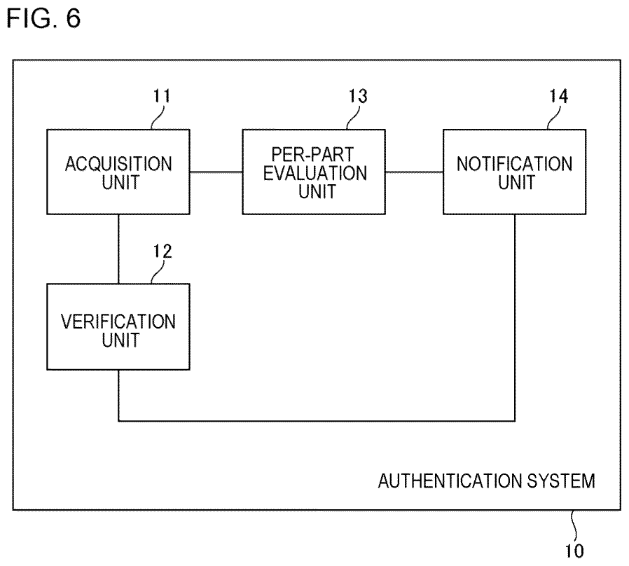

Next, a functional configuration of the authentication system 10 will be described. FIG. 2 illustrates one example of a functional block diagram of the authentication system 10. As illustrated, the authentication system 10 includes an acquisition unit 11, a verification unit 12, a per-part evaluation unit 13, a notification unit 14, and a storage unit 15. Note that, as illustrated in a functional block diagram in FIG. 6, the authentication system 10 may not include the storage unit 15. In this case, an external apparatus configured to be accessible from the authentication system 10 includes the storage unit 15.

The storage unit 15 stores various pieces of information. For example, the storage unit 15 stores a registration image being registered for face authentication. Other information stored by the storage unit 15 will be appropriately described below.

The acquisition unit 11 acquires a processing target image including a face of a user. In the present example embodiment, the acquisition unit 11 acquires, as the processing target image, an image being captured for face authentication, being input to the authentication system 10, and including a face of a user.

For example, the authentication system 10 may include a camera. Then, the acquisition unit 11 may acquire an image generated by the camera as the processing target image. The camera is installed in a position and an orientation in which the camera captures a face of a user who performs face authentication.

In addition, the authentication system 10 may receive an image including a face of a user from an external apparatus. Then, the acquisition unit 11 may acquire, as the processing target image, the image received from the external apparatus. The external apparatus is an apparatus having a camera function and a communication function, and, for example, a personal computer, a smartphone, a tablet terminal, a smartwatch, a cellular phone, a portable game, and the like are exemplified, which are not limited thereto. This example is assumed to be face authentication online.

The verification unit 12 performs face verification processing, based on the registration image preregistered in the storage unit 15 and the processing target image acquired by the acquisition unit 11. In the face verification processing, a whole face of a user indicated in the registration image and a whole face of the user indicated in the processing target image are verified, and a verification score according to a verification result is computed. In the present example embodiment, as a face of a user indicated in the registration image and a face of the user indicated in the processing target image are more similar to each other, a value of a verification score is assumed to increase, or vice versa. In the verification, the verification unit 12 may perform verification for each part of a face. However, even in this case, the verification unit 12 integrates a verification result for each part of the face, and computes and outputs a result of verification in a whole face. The result of the verification is a verification score. The face verification processing by the verification unit 12 can be achieved by using various techniques.

The storage unit 15 stores, in association with each user, a verification score computed by the verification unit 12. The storage unit 15 may store, as a verification history, a verification score of each piece of the face verification processing performed in a past period. The past period may be a latest predetermined period, or may be another period.

The per-part evaluation unit 13 evaluates a change in a part of a face, based on the registration image preregistered in the storage unit 15 and the processing target image acquired by the acquisition unit 11. As described above, the processing target image is an image including a face of a user and being input to the authentication system 10 for face authentication. In the present example embodiment, various evaluation techniques can be adopted, but one example will be described below.

In the example, the per-part evaluation unit 13 generates a three-dimensional registration image and a three-dimensional processing target image from a two-dimensional registration image and a two-dimensional processing target image, and verifies the three-dimensional registration image and the three-dimensional processing target image with each other. In this case, the per-part evaluation unit 13 extracts a plurality of keypoints for each part of a face from each of the three-dimensional registration image and the three-dimensional processing target image. An extraction result includes information indicating a position of each of the plurality of keypoints by coordinates in a three-dimensional coordinate system, and the like. Then, the per-part evaluation unit 13 computes a difference in the keypoint between the three-dimensional registration image and the three-dimensional processing target image, for example, a change amount of the keypoint for each part of the face, based on the extraction result.

As a part of a face, an eye, a nose, a mouth, an eyebrow, a jaw, an ear, and the like are exemplified, which are not limited thereto.

The storage unit 15 stores, in association with each user, an evaluation result of a change for each part of a face being computed by the per-part evaluation unit 3. The storage unit 15 may store, as a verification history, an evaluation result of a change for each part of a face being computed in a past period. The past period may be a latest predetermined period, or may be another period. Further, only when a change at a predetermined level or higher is detected, the storage unit 15 may store the evaluation result of the change in the part of the face. “When a change at a predetermined level or higher is detected” is, for example, when a change amount being equal to or more than a threshold value is detected. In other words, the storage unit 15 may not store the evaluation result described above when a change at a predetermined level or higher is not detected. “When a change at a predetermined level or higher is not detected” is, for example, when a change amount being equal to or more than a threshold value is not detected.

When a verification score of the face verification processing by the verification unit 12 satisfies a predetermined condition, the notification unit 14 notifies a notification target person of an evaluation result of a change for each part of a face.

As described above, in the present example embodiment, as a face of a user indicated in the registration image and a face of the user indicated in the processing target image are more similar to each other, a value of a verification score of the face verification processing increases. The predetermined condition described above in this case is that the “verification score is equal to or less than a reference value”. In other words, when a degree of similarity between a face of a user indicated in the registration image and a face of the user indicated in the processing target image is equal to or lower than a reference level, the notification unit 14 makes the notification described above.

The notification target person is, for example, a user. In this case, the notification unit 14 may make notification about an evaluation result of a change for each part of a face together with a result of the face verification processing. The result of the face verification processing indicates a result of face authentication, i.e., an authentication success or an authentication failure. The notification unit 14 can make the notification via, for example, a display, a speaker, a projection apparatus, and a user terminal. The user terminal is, for example, a personal computer, a smartphone, a tablet terminal, a smartwatch, a cellular phone, a portable game, and the like.

In addition, the notification target person may be an operator of the authentication system 10, or a person in charge of a facility that uses the authentication system 10. In this case, the notification unit 14 may notify the notification target person by real time processing, or may notify the notification target person by batch processing. In the latter case, a list of users who satisfy the predetermined condition described above may be provided to the notification target person together with the evaluation result of the change for each part of the face described above.

The notification unit 14 can make notification about, as an evaluation result of a change for each part of a face, at least one of
a guide of an update of a registration image, information indicating a part of a face in which a change at a reference level or higher is detected,
information indicating a degree of a change in a part of a face in which a change at a reference level or higher is detected,
information indicating a transition of a change in a part of a face in which a change at a reference level or higher is detected,
information indicating the number of times of detection in a part of a face in which a change at a reference level or higher is detected,
   information indicating the number of times a change at a reference level or higher is detected in a part of each face,
information indicating a degree of a change in a part of each face, and information indicating a transition of a change in a part of each face. In addition, the notification unit 14 may notify the notification target person of information indicating a transition of a verification score of the face verification processing by the verification unit 12.

The “guide of an update of a registration image” promotes consideration of an update of a registration image, and may be, for example, a sentence such as “Please consider an update of a registration image.”. Other information is a material for each user to appropriately decide whether an update of image data registered for face authentication is necessary.

The “information indicating a part of a face in which a change at a reference level or higher is detected” is, for example, information indicating a part of the face described above in which a change amount computed for each part of the face has been equal to or more than a threshold value.

The “information indicating a degree of a change in a part of a face in which a change at a reference level or higher is detected” is generated based on a change amount computed for each part of the face described above. The information may indicate the change amount itself computed for each part of the face, or may be information in which the change amount computed for each part of the face is converted into another index. The conversion is achieved based on a conversion reference such as, for example, “change amount equal to or more than A1: great change” and “change amount smaller than A1, equal to or more than A2: slightly great change”.

The “information indicating a transition of a change in a part of a face in which a change at a reference level or higher is detected” is generated based on a change amount computed for each part of the face described above. The information may be information in which a change amount computed for each part of the face or a value of another index converted from the change amount is arranged in time series, or may be information in which a time change in the change amount computed for each part of the face is displayed in a graph.

The “information indicating the number of times of detection in a part of a face in which a change at a reference level or higher is detected” is, for example, information indicating a part of the face described above in which a change amount computed for each part of the face has been equal to or more than a threshold value, and information indicating the number of times the change amount has been equal to or more than the threshold value.

The “information indicating the number of times a change at a reference level or higher is detected in a part of each face” indicates a content similar to the “information indicating the number of times of detection in a part of a face in which a change at a reference level or higher is detected” described above. However, it is different that the “information indicating the number of times of detection in a part of a face in which a change at a reference level or higher is detected” includes only information about a part of a face in which a change at a reference level or higher is detected, whereas the “information indicating the number of times a change is detected in a part of each face” does not have such a limitation. The “information indicating the number of times a change at a reference level or higher is detected in a part of each face” may include, for example, information about all parts of a face. In the “information indicating the number of times a change at a reference level or higher is detected in a part of each face”, for example, all parts of a face are displayed in a list, and the number of times a change at the reference level or higher is detected is indicated in association with a part of each face. Note that, in a part of the face in which the change at the reference level or higher is not detected, “0” is indicated as the number of times described above.

The “information indicating a degree of a change in a part of each face” indicates a content similar to the “information indicating a degree of a change in a part of a face in which a change at a reference level or higher is detected” described above. However, it is different that the “information indicating a degree of a change in a part of a face in which a change at a reference level or higher is detected” includes only information about a part of a face in which a change at a reference level or higher is detected, whereas the “information indicating a degree of a change in a part of each face” does not have such a limitation. The “information indicating a degree of a change in a part of each face” may include, for example, information about all parts of a face. In the “information indicating a degree of a change in a part of each face”, for example, all parts of a face are displayed in a list, and information indicating a degree of a change is displayed in association with a part of each face. The information indicating a degree of a change may indicate a change amount itself computed for each part of a face, or may be information in which the change amount computed for each part of the face is converted into another index. The conversion is achieved based on a conversion reference such as, for example, “change amount equal to or more than A1: great change”, “change amount smaller than A1, equal to or more than A2: slightly great change”, and “change amount smaller than A2, equal to or more than A3: small”.

The “information indicating a transition of a change in a part of each face” indicates a content similar to the “information indicating a transition of a change in a part of a face in which a change at a reference level or higher is detected” described above. However, it is different that the “information indicating a transition of a change in a part of a face in which a change at a reference level or higher is detected” includes only information about a part of a face in which a change at a reference level or higher is detected, whereas the “information indicating a transition of a change in a part of each face” does not have such a limitation. The “information indicating a transition of a change in a part of each face” may include, for example, information about all parts of a face. In the “information indicating a transition of a change in a part of each face”, for example, all parts of a face are displayed in a list, and information indicating a transition of a change is displayed in association with a part of each face.

The “information indicating a transition of a verification score of the face verification processing by the verification unit 12” may be information in which a verification score of the face verification processing is arranged in time series, or may be information in which a time change in the verification score of the face verification processing is displayed in a graph.

Further, when a registration date of a registration image is stored in the storage unit 15, the notification unit 14 may further notify a notification target person of the registration date of the registration image.

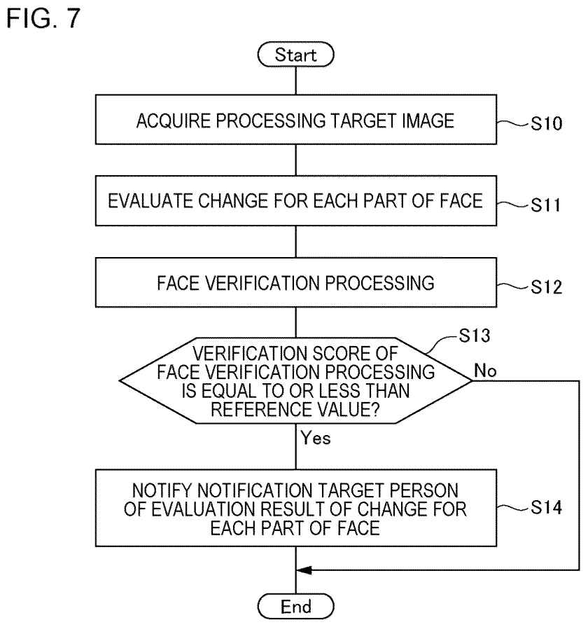

Next, one example of a flow of processing of the authentication system 10 will be described by using the flowchart in FIG. 7.

When the authentication system 10 acquires a processing target image including a face of a user (S10), the authentication system 10 evaluates a change for each part of the face, based on a preregistered registration image and the processing target image acquired in S10 (S11). Further, the authentication system 10 performs face verification processing, based on the preregistered registration image and the processing target image acquired in S10 (S12). Then, when a predetermined condition that a verification score of the face verification processing is equal to or less than a reference value is satisfied (Yes in S13), the authentication system 10 notifies a notification target person of an evaluation result of the change for each part of the face (S14). When the predetermined condition that a verification score of the face verification processing is equal to or less than the reference value is not satisfied (No in S13), the authentication system 10 does not notify the notification target person of an evaluation result of the change for each part of the face.

Note that, a processing order of the processing in S11 and the processing in S12 is not limited to the illustrated example. The processing in S11 may be performed after the processing in S12, or the processing in S11 and the processing in S12 may be simultaneously performed.

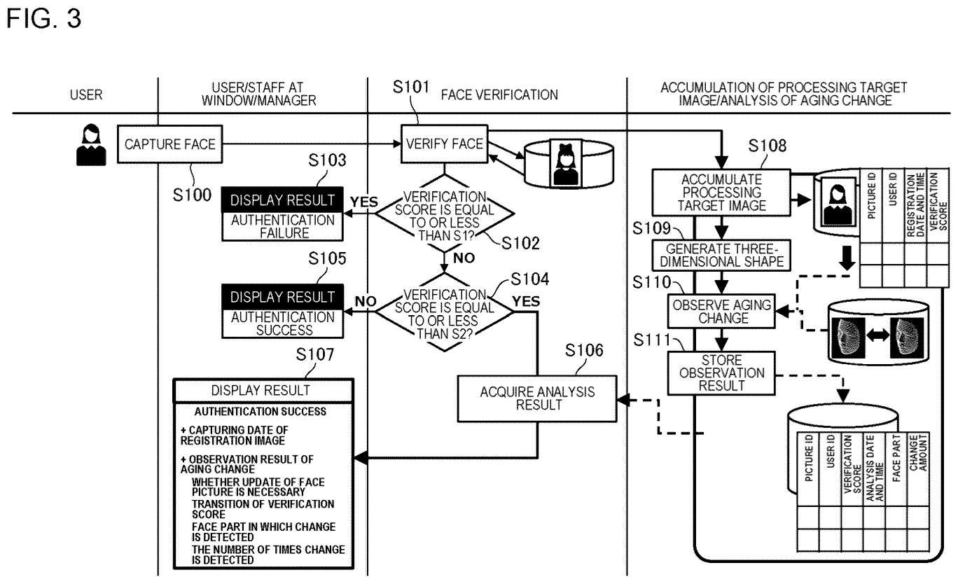

Next, one example of a flow of processing of the authentication system 10 will be described in more detail by using FIG. 3.

First, a user who performs face authentication performs an operation of capturing his/her face image (S100). The face authentication is performed for personal identification at a time of, for example, a login to a predetermined system, an entry into a predetermined facility, reception of a service provided by a company and an administration, and the like. An apparatus that captures a face image of the user may be a dedicated apparatus installed in a predetermined position, or may be a user terminal of the user himself/herself. As the predetermined position in which the dedicated apparatus is installed, an entrance of a facility and the like are exemplified, which are not limited thereto. The user terminal is a personal computer, a smartphone, a tablet terminal, a smartwatch, a cellular phone, a portable game, and the like, which are not limited thereto. A two-dimensional face image being captured is transmitted to the authentication system 10 through wired and/or wireless communication.

The authentication system 10 performs face verification processing of acquiring the two-dimensional face image described above as a processing target image, and verifying a preregistered two-dimensional registration image (S101).

When a verification score is equal to or less than S1 (Yes in S102), the authentication system 10 notifies the user of a failure in the face authentication (S103). The notification may be made via the dedicated apparatus installed in the predetermined position, or may be made via the user terminal of the user himself/herself. S1 is a threshold value defined by using a numerical value indicating a verification score, and indicates a boundary between a success and a failure in the face authentication.

Further, when the verification score is not equal to or less than S1 (No in S102) and the verification score is also not equal to or less than S2 (No in S104), the authentication system 10 notifies the user of a success in the face authentication (S105). S2 is a threshold value defined by using a numerical value indicating a verification score, and indicates a boundary of whether to make notification about an evaluation result of a change for each part of a face. Note that, S1<S2. The notification may be made via the dedicated apparatus installed in the predetermined position, or may be made via a user terminal of the user himself/herself.

Further, when the verification score is not equal to or less than S1 (No in S102) and the verification score is equal to or less than S2 (Yes in S104), the authentication system 10 reads, from the storage unit 15, an evaluation result of a change for each part of a face registered in association with the user (S106). Then, the authentication system 10 notifies the user of a success in the face authentication and the evaluation result of the change for each part of the face (S107). The notification may be made via the dedicated apparatus installed in the predetermined position, or may be made via the user terminal of the user himself/herself. FIG. 3 illustrates one example of information notified together with a success in the face authentication, which is not limited thereto.

Further, the authentication system 10 stores, in the storage unit 15, the processing target image and the verification score being a result of the face verification in S101 in association with each other (S108).

For example, as illustrated in FIG. 3, the storage unit 15 stores information in which a picture identifier (ID) being information for identifying processing target images from each other, a user ID being information for identifying users from each other, a registration date and time being a date and time at which the processing target image is registered in the storage unit 15, and the verification score being the result of the face verification in S101 are associated with one another.

Furthermore, the authentication system 10 generates a three-dimensional processing target image from the acquired two-dimensional processing target image (S109). Then, the authentication system 10 evaluates the change for each part of the face, based on the three-dimensional processing target image generated from the acquired two-dimensional processing target image, and a three-dimensional registration image generated from the two-dimensional registration image of the user being stored in the storage unit 15 (S110). Then, the authentication system 10 stores the evaluation result in S110 in the storage unit 15 (S111).

For example, as illustrated in FIG. 3, the storage unit 15 stores information in which the picture ID, the user ID, the verification score, an analysis date and time, face part information, and change amount information are associated with one another. The picture ID, the user ID, and the verification score are as described above. The analysis date and time indicates a date and time at which the processing in S110 is performed. The face part information indicates a part of a face in which a change at a reference level or higher is detected. The change amount indicates a change amount of a part of a face in which a change at a reference level or higher is detected.

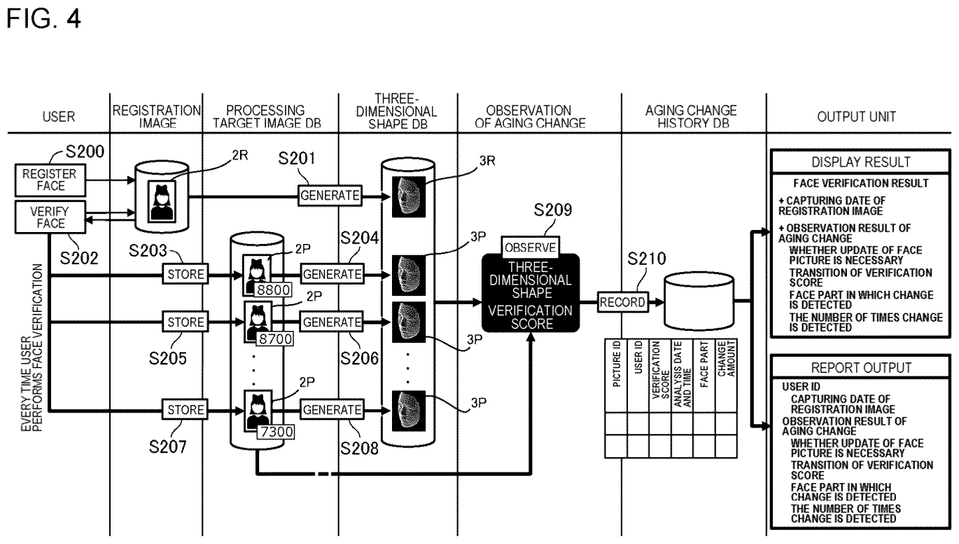

Next, the processing in S108 to S111 in FIG. 3 will be specifically described by using FIG. 4. Note that, processing other than the processing in S108 to S111 in FIG. 3 is also included in a flow in FIG. 4.

First, a user performs an operation of registering a two-dimensional registration image 2R including his/her face in the authentication system 10. The authentication system 10 acquires the two-dimensional registration image 2R, and stores the two-dimensional registration image 2R in the storage unit 15 (S200). Details of the operation performed by the user for the registration of the two-dimensional registration image 2R and the processing in S200 are not particularly limited. Next, the authentication system 10 generates a three-dimensional registration image 3R from the two-dimensional registration image 2R, and stores the three-dimensional registration image 3R in the storage unit 15 (S201).

Subsequently, every time a user performs face authentication, i.e., every time a processing target image 2P including a face of a user generated for the face authentication is input to the authentication system 10, the authentication system 10 performs the following processing.

First, the authentication system 10 stores, in the storage unit 15, the processing target image 2P and a verification score being a result of the face verification in S101 in FIG. 3 in association with each other (S203, S205, and S207). Further, the authentication system 10 generates a three-dimensional processing target image 3P from each two-dimensional processing target image 2P stored in the storage unit 15, and stores the three-dimensional processing target image 3P in the storage unit 15 (S204, S206, and S208).

Then, the authentication system 10 evaluates a change in a part of a face for each part of the face, based on the three-dimensional registration image 3R generated from the two-dimensional registration image 2R, and the three-dimensional processing target image 3P generated from the two-dimensional processing target image 2P. For example, the authentication system 10 computes the change amount described above for each part of the face (S209). Next, the authentication system 10 stores an evaluation result in S209 in the storage unit 15 (S210).

One example of information notified to the notification target person by the notification unit 14 of the authentication system 10 is indicated in a column of “output unit” in FIG. 4. Information included in “result display” is one example of information notified to a user. “Report output” is one example of information notified to an operator of the authentication system 10, and a person in charge of a facility that uses the authentication system 10.

### Advantageous Effect

The authentication system 10 according to the present example embodiment notifies a notification target person of an evaluation result of a change for each part of a face when a predetermined condition is satisfied. The notification target person can appropriately decide, based on the evaluation result of the change for each part of the face, whether an update of image data registered for face authentication is necessary even when, for example, a timing of the update is not reached. Further, even when personal authentication is performed by a face authentication technique at a high level, a change seen with eyes of a person may be great, and image data may not be appropriate as image data to be registered for authentication. Also in this case, in the present example embodiment, image data registered for face authentication can be updated to latest image data at an appropriate timing of an individual in response to a change in a face.

Further, the authentication system 10 according to the present example embodiment can limit notification of the evaluation result described above to a case where a predetermined condition is satisfied. With such a configuration, an inconvenience of unnecessarily making the notification, and unnecessarily promoting a user and the like to decide whether an update of image data registered for face authentication is necessary can be suppressed.

Further, in a case of the present example embodiment, the predetermined condition described above can be set to a “case where a verification score of face verification processing based on a registration image and a processing target image is equal to or less than the reference value S2”, i.e., a case where a degree of similarity between the registration image and the processing target image is equal to or less than the reference value S2. By appropriately setting the predetermined condition in this way, notification of the evaluation result described above can be made to a user and the like at an appropriate timing, and a decision of whether an update of image data registered for face authentication is necessary can be promoted.

Further, the authentication system 10 can notify, with respect to a notification target person, the notification target person of at least one of information indicating a part of a face in which a change at a reference level or higher is detected, information indicating a degree of a change in a part of a face in which a change at a reference level or higher is detected, information indicating a transition of a change in a part of a face in which a change at a reference level or higher is detected, information indicating the number of times of detection in a part of a face in which a change at a reference level or higher is detected, information indicating the number of times a change at a reference level or higher is detected in a part of each face, information indicating a degree of a change in a part of each face, information indicating a transition of a change in a part of each face, and information indicating a transition of a verification score of the face verification processing by the verification unit 12. The notification target person can appropriately decide whether an update of image data registered for face authentication is necessary, based on such beneficial information.

### Second Example Embodiment

In the first example embodiment, when the predetermined condition that a verification score of the face verification processing by the verification unit 12 is equal to or less than the reference value is satisfied, the notification unit 14 makes notification about an evaluation result of a change for each part of a face. In the present example embodiment, when a verification score of face verification processing by a verification unit 12 satisfies the predetermined condition described above, and an evaluation result of a change for each part of a face satisfies one or a plurality of conditions of other predetermined conditions, a notification unit 14 notifies a notification target person of the evaluation result of the change for each part of the face.

The other predetermined conditions are

that a part of a face in which a change at a reference level or higher is detected is present,

that a part of a face in which a change at a reference level or higher is detected for a predetermined number of times or more is present,

that a predetermined number or more of parts of a face in which a change at a reference level or higher is detected is present,

that a predetermined number or more of parts of a face in which a change at a reference level or higher is detected for a predetermined number of times or more is present,

that a change at a reference level or higher is detected in a preregistered important part of a face,

that a change at a reference level or higher is detected for a predetermined number of times or more in a preregistered important part of a face, or

that a part of a face in which a change at a reference level or higher is detected is present, and the detected part of the face undergoing an operation is registered in operation history information.

The “reference level described above” can be defined by using the change amount described in the first example embodiment.

The “preregistered important part of a face” is a part of a face having a high degree of importance in face authentication. Which part of a face is set as an important part of the face is not particularly limited, but, for example, an eye, a nose, a mouth, and the like may be handled as the important part of the face.

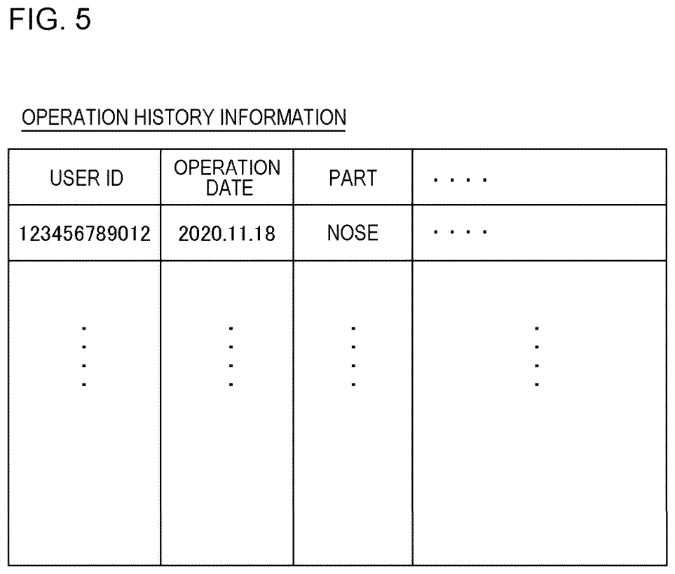

The “operation history information” is information indicating a history of an operation of each user. An external system stores the information. Then, an authentication system 10 acquires the operation history information from the external system. FIG. 5 schematically illustrates one example of the operation history information. In the illustrated operation history information, a user ID, an operation date, and an operated part of a face are registered in association with one another.

Note that, the user ID in the operation history information and a user ID managed by the authentication system 10 may be the same information, or may be different information. In a case of the same information, for example, identification information provided to a citizen by a nation, such as a national identification number, and the like may be used as the user ID. In a case of different information, a means for determining a correspondence between the user ID in the operation history information and the user ID managed by the authentication system 10 is needed. In this case, the correspondence between the two user IDs may be determined based on other information associated with each of the user ID in the operation history information and the user ID managed by the authentication system 10. The authentication system 10 determines, as a user ID of the same user, a combination of the “user ID in the operation history information” and the “user ID managed by the authentication system 10” having the other information coinciding. As the other information, an address, a phone number, a date of birth, and the like are exemplified, which are not limited thereto.

Another configuration of the authentication system 10 according to the present example embodiment is similar to that in the first example embodiment.

The authentication system 10 according to the present example embodiment achieves an advantageous effect similar to that in the first example embodiment. Further, in a case of the present example embodiment, a predetermined condition for notifying a notification target person of an evaluation result of a change for each part of a face can be set as a “case where a verification score of face verification processing based on a registration image and a processing target image is equal to or less than a reference value (a case where a degree of similarity is equal to or less than a reference value), and an evaluation result of a change for each part of a face satisfies the other predetermined conditions described above”, i.e., a case where a degree of similarity between a registration image and a processing target image is equal to or less than a reference value, and an evaluation result of a change for each part of a face satisfies the other predetermined conditions described above. By appropriately setting the predetermined condition in this way, notification of the evaluation result described above can be made to a user at an appropriate timing, and a decision of whether an update of image data registered for face authentication is necessary can be promoted. Then, an inconvenience of unnecessarily making the notification, and unnecessarily promoting a user to decide whether an update of image data registered for face authentication is necessary can be suppressed.

### MODIFICATION EXAMPLE

### First Modification Example

In the example embodiments described above, the per-part evaluation unit 13 generates a three-dimensional registration image and a three-dimensional processing target image from a two-dimensional registration image and a two-dimensional processing target image, and evaluates a change for each part of a face, based on the three-dimensional registration image and the three-dimensional processing target image. As a modification example, the per-part evaluation unit 13 may not generate the three-dimensional registration image and the three-dimensional processing target image, and may evaluate a change for each part of a face with the two-dimensional registration image and the two-dimensional processing target image as they are.

### Second Modification Example

In the example embodiments described above, the acquisition unit 11 acquires, as a processing target image, an image input for face authentication. As a modification example, the acquisition unit 11 may acquire, as a processing target image, an image different from an image input for face authentication. Further, the acquisition unit 11 may acquire, as a processing target image, both of an image input for face authentication and an image different from the image input for the face authentication.

For example, the acquisition unit 11 may acquire, from an external system, a face image of a user input to the external system. A function of the external system, a content of a service provided to a user, and the like are not particularly limited.

In this case, a user ID managed by the external system and a user ID managed by the authentication system 10 may be the same information, or may be different information. In a case of the same information, for example, identification information provided to a citizen by a nation, such as a national identification number, and the like may be used as the user ID. In a case of different information, a means for determining a correspondence between the user ID managed by the external system and the user ID managed by the authentication system 10 is needed. In this case, the correspondence between the two user IDs may be determined based on other information associated with each of the user ID managed by the external system and the user ID managed by the authentication system 10. The authentication system 10 determines, as a user ID of the same user, a combination of the “user ID managed by the external system” and the “user ID managed by the authentication system 10” having the other information coinciding. As the other information, an address, a phone number, a date of birth, and the like are exemplified, which are not limited thereto. The external system is a system for performing face authentication, and may be a system different from the authentication system 10 or may be a system having another function.

### Third Modification Example

In the flow of the processing described by using FIG. 3 in the first example embodiment, when a verification score of the face verification processing by the verification unit 12 is equal to or less than S1 (Yes in S102), the authentication system 10 notifies a user of only a failure in the face authentication (S103). As a modification example, when a verification score of the face verification processing by the verification unit 12 is equal to or less than S1 (Yes in S102), the authentication system 10 may notify a notification target person of a failure in the face authentication and an evaluation result of a change for each part of a face.

Note that, in this case, the face authentication has failed, and thus the authentication system 10 cannot determine a user who inputs a processing target image. Thus, the authentication system 10 may notify the notification target person of an evaluation result of a change for each part of a face of a user associated with a registration image having a highest verification score of the face verification processing with the processing target image.

An advantageous effect similar to that in the example embodiments described above is also achieved in the modification examples.

Note that, in the present specification, “acquisition” includes at least any one of “acquisition of data stored in another apparatus or a storage medium by its own apparatus (active acquisition)”, based on a user input or an instruction of a program, such as reception by making a request or an inquiry to another apparatus and reading by accessing to another apparatus or a storage medium, “inputting of data output to its own apparatus from another apparatus (passive acquisition)”, based on a user input or an instruction of a program, such as reception of data to be distributed (transmitted, push-notified, or the like) and acquisition by selection from among received data or received information, and “creation of new data by editing data (such as texting, sorting of data, extraction of a part of data, and change of a file format) and the like, and acquisition of the new data”.

A part or the whole of the above-described example embodiment may also be described in supplementary notes below, which is not limited thereto.

1. An authentication system including:
an acquisition unit that acquires a processing target image including a face of a user;
a per-part evaluation unit that evaluates a change for each part of a face, based on a registration image being preregistered and the processing target image;
a verification unit that performs face verification processing, based on the registration image and the processing target image; and
a notification unit that notifies a notification target person of an evaluation result of a change for each part of a face when a verification score of the face verification processing satisfies a predetermined condition.
   2. The authentication system according to supplementary note 1, wherein
the notification unit notifies the notification target person of information about a part of a face in which a change at a reference level or higher is detected.
   3. The authentication system according to supplementary note 1 or 2, wherein
the notification unit notifies the notification target person of information indicating a transition of the verification score.
   4. The authentication system according to any one of supplementary notes 1 to 3, wherein
the notification unit notifies the notification target person of the evaluation result, when a verification score of the face verification processing satisfies a predetermined condition and the evaluation result satisfies another predetermined condition.
   5. The authentication system according to supplementary note 4, wherein
the another predetermined condition is defined based on a change for each part of a face.
   6. The authentication system according to any one of supplementary notes 1 to 5, wherein
the evaluation unit evaluates a change for each part of a face, based on a three-dimensional registration image generated from the registration image being two-dimensional, and a three-dimensional processing target image generated from the processing target image being two-dimensional.
   7. The authentication system according to any one of supplementary notes 1 to 6, wherein
the notification unit notifies the user of the evaluation result together with a result of the face verification processing.
   8. The authentication system according to any one of supplementary notes 1 to 7, wherein
the notification unit notifies, of the evaluation result, a manager who manages the registration image of a plurality of the users.
   9. A processing method including,
by a computer:
acquiring a processing target image including a face of a user;
evaluating a change for each part of a face, based on a registration image being preregistered and the processing target image;
performing face verification processing, based on the registration image and the processing target image; and
notifying a notification target person of an evaluation result of a change for each part of a face when a verification score of the face verification processing satisfies a predetermined condition.
   10. A program causing a computer to function as:
an acquisition unit that acquires a processing target image including a face of a user;
a per-part evaluation unit that evaluates a change for each part of a face, based on a registration image being preregistered and the processing target image;
a verification unit that performs face verification processing, based on the registration image and the processing target image; and
a notification unit that notifies a notification target person of an evaluation result of a change for each part of a face when a verification score of the face verification processing satisfies a predetermined condition.

This application is based upon and claims the benefit of priority from Japanese patent application No. 2021-066319, filed on Apr. 9, 2021, the disclosure of which is incorporated herein in its entirety by reference.

### REFERENCE SIGNS LIST

10 Authentication system
11 Acquisition unit
12 Verification unit
13 Per-part evaluation unit
14 Notification unit
15 Storage unit
1A Processor
2A Memory
3A Input/output I/F
4A Peripheral circuit
5A Bus

What is claimed is:

1. An authentication system comprising:
at least one memory configured to store one or more instructions; and
at least one processor configured to execute the one or more instructions to:
acquire a processing target image including a face of a user;
evaluate a change for each part of a face, based on a registration image being preregistered and the processing target image;
perform face verification processing, based on the registration image and the processing target image; and
notify a notification target person of an evaluation result of a change for each part of a face when a verification score of the face verification processing satisfies a predetermined condition.

2. The authentication system according to claim 1, wherein
the processor is further configured to execute the one or more instructions to notify the notification target person of information about a part of a face in which a change at a reference level or higher is detected.

3. The authentication system according to claim 1, wherein
the processor is further configured to execute the one or more instructions to notify the notification target person of information indicating a transition of the verification score.

4. The authentication system according to claim 1, wherein
the processor is further configured to execute the one or more instructions to notify the notification target person of the evaluation result, when a verification score of the face verification processing satisfies a predetermined condition and the evaluation result satisfies another predetermined condition.

5. The authentication system according to claim 4, wherein
the another predetermined condition is defined based on a change for each part of a face.

6. The authentication system according to claim 1, wherein
the processor is further configured to execute the one or more instructions to evaluate a change for each part of a face, based on a three-dimensional registration image generated from the registration image being two-dimensional, and a three-dimensional processing target image generated from the processing target image being two-dimensional.

7. The authentication system according to claim 1, wherein
the processor is further configured to execute the one or more instructions to notify the user of the evaluation result together with a result of the face verification processing.

8. The authentication system according to claim 1, wherein
the processor is further configured to execute the one or more instructions to notify, of the evaluation result, a manager who manages the registration image of a plurality of the users.

9. A processing method comprising,
by a computer:
acquiring a processing target image including a face of a user;
evaluating a change for each part of a face, based on a registration image being preregistered and the processing target image;
performing face verification processing, based on the registration image and the processing target image; and
notifying a notification target person of an evaluation result of a change for each part of a face when a verification score of the face verification processing satisfies a predetermined condition.

10. A non-transitory storage medium storing a program causing a computer to:
acquire a processing target image including a face of a user;
evaluate a change for each part of a face, based on a registration image being preregistered and the processing target image;
perform face verification processing, based on the registration image and the processing target image; and
notify a notification target person of an evaluation result of a change for each part of a face when a verification score of the face verification processing satisfies a predetermined condition.
